(19) United States
(12) Patent Application Publication
(10) Pub. No.: US 2011/0318531 A1
(43) Pub. Date: Dec. 29, 2011

(54) HEAT SHIELD ELEMENT OF A HEAT SHIELD

(76) Inventor: Claus Krusch, Mulheim an der Ruhr (DE)

(21) Appl. No.: 13/255,574

(22) PCT Filed: Dec. 2, 2009
(86) PCT No.: PCT/EP2009/066243

§ 371 Date: Sep. 9, 2011

(30) Foreign Application Priority Data
Mar. 17, 2009 (EP) 09155390.9

(51) Int. Cl. B32B 3/10; B23P 11/00

(52) U.S. Cl. 428/131; 29/525.11

(57) ABSTRACT

A heat shield element for a heat shield including heat shield elements disposed adjacently on a support structure is provided. The heat shield element includes a hot side and a cold side, provided for mounting on the support structure as a closing final heat shield element and includes a heat shield plate forming the hot side and a carrier plate forming the cold side, wherein the heat shield plate may be mounted on the carrier plate. A through hole is provided in the heat shield plate to mount it on the carrier plate. A depression having a through-hole is provided in the carrier plate at a position corresponding to the through-hole of the heat shield plate, through which a screw is inserted, wherein the head of the screw is captured in a space formed by the depression and the side of the heat shield plate facing the carrier plate.

### CROSS REFERENCE TO RELATED APPLICATIONS

This application is the US National Stage of International Application No. PCT/EP2009/066243, filed Dec. 2, 2009 and claims the benefit thereof. The International Application claims the benefits of German application No. 09155390. DE filed Mar. 17, 2009. All of the applications are incorporated by reference herein in their entirety.

### FIELD OF INVENTION

The invention relates to a heat shield element of a heat shield, to a heat shield on a support structure, to a use of the heat shield for turbine machines and to a method for assembling the heat shield element, comprising the features cited in the preambles of the respective independent claims.

### BACKGROUND OF INVENTION

Powerful ceramic heat shields are used in many applications to withstand temperatures between 1,000 and 1,600 degrees Celsius. The heat shields of turbine machines such as gas turbines and turbine engines, in particular as are used in electricity-generating power plants and in larger aircraft, have correspondingly large surfaces in the interior of their combustion chambers that are to be shielded by heat shields. Owing to their thermal expansion and owing to large dimensions, the shield must be assembled from a large number of individual heat shield elements made from ceramic and which are to be spaced apart from each other by an adequate gap. This gap provides the heat shield elements with sufficient space for thermal expansion. However, since the gap also allows the hot combustion gases to have direct contact with the support structure carrying the heat shield, a cooling fluid in the form of cooling air is blown in through the gap via cooling ducts and in the direction of the combustion chamber as an effective countermeasure. This cooling air is also used to purposefully blow on and therefore cool the metal mounts with which the ceramic heat shield elements (CHS, Ceramic Heat Shields) are clamped to the support structure. In a further improved arrangement cooling air is also blown in below the ceramic heat shield elements to allow cooling of the bottom.

To design the mounts so they are as simple as possible and in one part, a construction is known in which these mounts can be inserted so as to engage in encircling parallel grooves formed in the support structure on the one hand and on the other hand are clamped by gripping sections to holder grooves in which ceramic heat shield elements are formed in the side surfaces. The heat shield elements are successively inserted with the holders in the grooves of the support structure, the following elements locking the previously positioned elements in their positions. An encircling row of heat shield elements by way of example is formed in a combustion chamber of a gas turbine in this way.

The last remaining heat shield element can no longer be assembled in this way, however, because the adjacent heat shield elements that are on either side block a tangentially oriented assembly movement. A final heat shield element of this kind is often called a dummy brick or dummy element. Solutions with screw connections are consequently used to attach the last heat shield element, and these allow assembly in the direction of the surface normals of the support structure. A known screw connection uses four screws for this purpose and these engage in recesses which are formed in the side surfaces of the heat shield element for this purpose. This solution is multiply disadvantaged because, firstly, the four screws require additional cooling and consequently more cooling air consumption and, secondly, assembly entails a handling problem. Handling of the four screws requires, by way of example, use of fixing means, such as adhesive or adhesive tape, which are not reliable, whereby the screws can become lost and owing to a high risk of damage it is imperative that they are found. Furthermore, no over-head assembly is possible, so considerable time must be spent positioning a large turbine assembly in the corresponding assembly-friendly six o'clock position of the assembly site. It may also be necessary to employ two people for assembly of the last heat shield element since the four screws have to be introduced into the corresponding four holes in the support structure. Last of all it should also be taken into account that the screws are relatively expensive owing to the high heat-resistant alloy used and owing to high safety requirements have to be replaced with new ones with every disassembly.

EP 1 701 095 A1 and EP 0 558 540 B1 describe by way of example a heat shield designed as described above and having the depicted advantages and disadvantages. The heat shield elements are often also called bricks and the retaining elements that hold them, also known as brick holders.

EP 1 533 572 A1 discloses a heat shield element comprising a heat shield of a gas turbine combustion chamber having a large number of heat shield elements disposed adjacently on a support structure. The disclosed heat shield element comprises a ceramic lining element forming the hot side and an insulating part forming the cold side. A screw connection is arranged inside a hole centrally penetrating the lining element and the insulating part for securing the heat shield element to the support structure.

EP 0 724 116 A2 also discloses a ceramic lining for combustion chambers comprising at least one heat shield element which for assembly of the heat shield element on a support structure comprises a continuous through hole which is penetrated by a securing element. The heat shield element comprises a ceramic wall plate forming the hot side and an insulating layer forming the cold side.

### SUMMARY OF INVENTION

In view of the above-described disadvantages in the prior art the object of the present invention is to design a heat shield element in such a way that it can be assembled as the last of a large number of heat shield elements of a heat shield, comprises a few assembly elements in the process and the heat-protecting function and the cooling fluid circulation are retained.

According to a first aspect the invention starts from a heat shield element for a heat shield comprising a large number of heat shield elements disposed adjacently on a support structure, wherein the heat shield element comprises a hot side and a cold side.

The inventive objects are achieved according to this aspect in that the heat shield element comprises a heat shield plate forming the hot side and a carrier plate forming the cold side, wherein the heat shield plate can be assembled on the carrier plate. It is hereby possible to divide the securing of the last heat shield element to the support structure into securing of the carrier plate to the support structure and securing of the carrier plate to the heat shield plate, and to advantageously design it accordingly.

The heat shield plate forming the hot side is preferably constructed from a heat-resistant sintered or ceramic material and the carrier plate fainting the cold side is constructed from a metal material or a metal alloy.

At least one through hole is provided in the heat shield plate in order to assemble the heat shield plate on the carrier plate, the position of this through hole being provided substantially as a symmetrical position in the surface of the heat shield plate. This one through hole is sufficient for actuating a screw connection. The transverse dimension of the through hole is preferably smaller than the diameter of the head of a fixing screw which can be inserted in the carrier plate.

According to a particularly preferred embodiment of the present invention a depression having a through hole is provided in the carrier plate at a position corresponding to the through hole of the heat shield plate, through which the fixing screw can be inserted, wherein the head of the fixing screw is captured in a space formed by the depression and the side of the heat shield plate facing the carrier plate. The fixing screw consequently cannot be lost.

The heat shield plate preferably comprises a respective holder groove, located in the two lateral edges that oppose and face away from each other, which are provided for engaging the retaining elements by way of gripping sections.

To receive and secure the retaining element the carrier plate comprises at least one groove which has a widened groove base and a constricted region forming the open side of the groove.

Further advantages may be achieved with an inventive embodiment if the carrier plate and the heat shield plate are clamped together with the aid of at least two retaining elements, the retaining element comprising means for engaging in the holder grooves of the heat shield plate and means for engaging in the grooves of the carrier plate.

The means constructed in the retaining element for engaging in the holder grooves of the heat shield plate are preferably constructed as gripping sections.

The means constructed in the retaining element for engaging in the grooves of the carrier plate are also preferably constructed as a widened shoe whose width corresponds with the width of the widened groove base of the groove of the carrier plate.

The retaining element can also comprise a fastening section serving as a retaining spring and whose width corresponds with the width of the constricted region of the groove of the carrier plate.

The thickness of the heat shield plate and the thickness of the carrier plate preferably produce a total thickness of the inventive two-part heat shield element which matches the thickness of a one-part ceramic heat shield element.

According to a second aspect the inventive objects are achieved with a heat shield on a support structure comprising a large number of heat shield elements, comprising at least one heat shield element according to a previously described embodiment.

For this purpose the inventive heat shield element is provided as a final heat shield element ending a row of pre-assembled adjacent heat shield elements.

According to the invention the objects of the invention can also be achieved by a use of the heat shield comprising at least one heat shield element according to the previously described embodiment for producing a combustor or a turbine machine, wherein the turbine machine can in particular be designed as a gas turbine.

According to a process-engineering aspect a method for assembling a heat shield element according to one of the previously described preferred embodiments is used to achieve the inventive objects.

This inventive method is preferably characterized in that
the fixing screw is introduced into the hole provided in the depression,
the heat shield plate is clamped with the aid of at least two retaining elements, which are introduced with their respective shoe into the grooves of the carrier plate, to the metal carrier plate by engagement by means of the gripping sections of the holding elements in the holder grooves provided in the edges of the heat shield plate that face away from each other.

The inventive method provides additional advantages if at least one retaining element is non-positively secured to the carrier plate at the securing opening, the retaining element opposing this at least one secured retaining element being left unsecured.

According to the invention an embodiment as what is known as a pocket CHS (pocket brick) is also possible.

As a result it is possible according to the invention to produce a heat shield element which can be assembled in a straightforward manner as what is known as a dummy element as a final element of a heat shield and both heat protection and cooling of the metal retaining elements and carrier plate by way of cooling air is ensured in the process.

Further preferred embodiments of the invention emerge from the remaining features cited in the subclaims. Further inventive features, properties and advantages also emerge from the following description of the exemplary embodiments with reference to the accompanying figures.

### BRIEF DESCRIPTION OF THE DRAWINGS

The invention will be described hereinafter in exemplary embodiments with reference to the associated drawings, in which:

FIG. 1 shows a partial cross-section through a preferred embodiment of the inventive heat shield element,

FIG. 2 shows a side view of the inventive heat shield element,

FIG. 3 shows a perspective view of the inventive heat shield element,

FIG. 4 shows a perspective view of the support structure,

FIG. 5 shows a perspective view of the retaining element,

FIG. 6 shows an enlarged perspective partial view of the inventive heat shield element in the region of a retaining element.

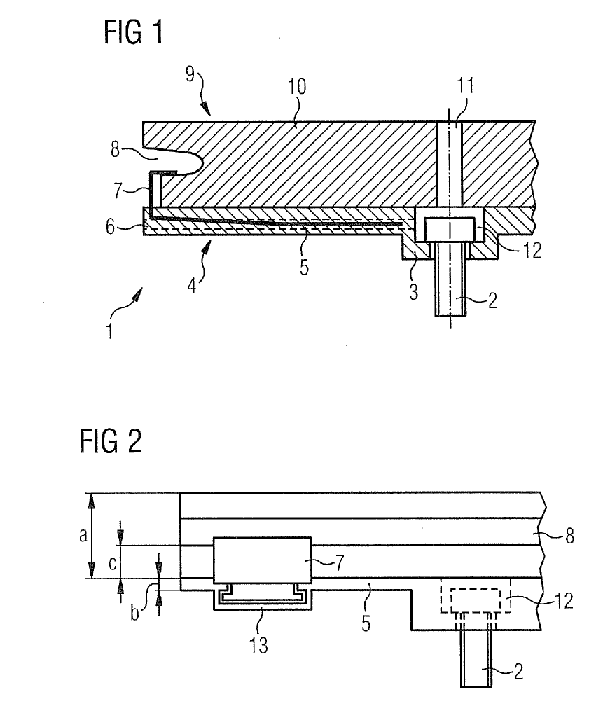

FIG. 1 shows a partial cross-section through a preferred embodiment of the inventive heat shield element 1.

### DETAILED DESCRIPTION OF INVENTION

According to the invention the heat shield element is constructed in two parts and preferably comprises a ceramic heat shield plate 10 and a preferably metal carrier plate 5. The total thickness of the two plates is chosen such that it is the same as the thickness of a normal, fully ceramic one-part heat shield element to form a uniformly thick heat shield.

The carrier plate preferably comprises a securing device which is substantially axially symmetrical in its center and comprises an extension 3 projecting toward the cold side 4 and a depression 12 which is perforated by a hole. A fixing screw 2 can be introduced into this securing hole.

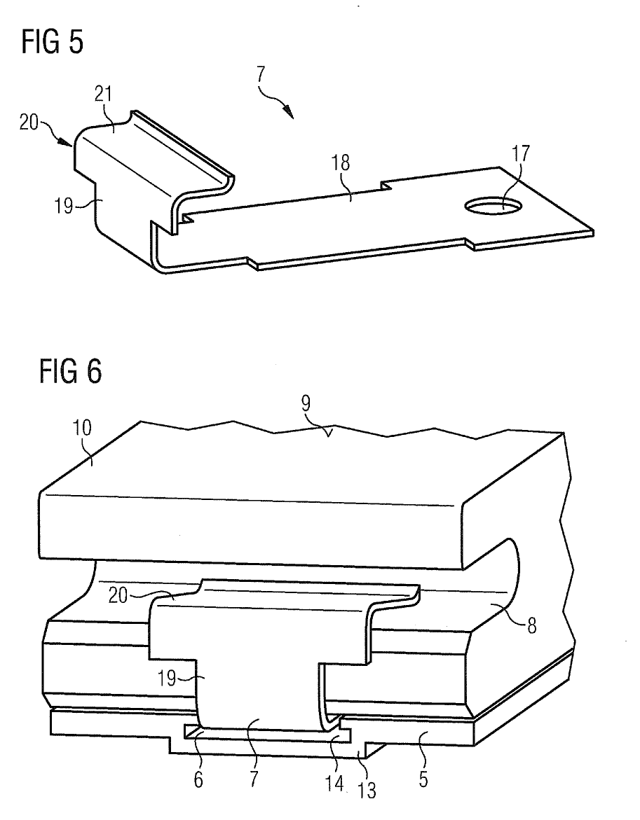

Both plates are clamped together with the aid of preferably resilient metal holders 7 (see FIGS. 5 and 6), the holder 7 engaging with its gripping section 21 in a lateral holder groove 8 of the heat shield plate 10.

The heat shield plate 10 comprises a through hole 11 which is arranged exactly over the fixing screw 2. An assembly tool (not shown) can be introduced through this through hole 11 to engage in the head of the screw 2 and to be able to turn it if the heat shield element is secured to a support structure. The diameter of the through hole 11 is chosen such that the assembly tool, by way of example a screw driver or an Allen key, passes freely through it. The diameter of the through hole 11 can consequently be kept as small as possible so less heat can penetrate into the hole from the hot side 9 and cause a heat problem there.

Since the head of the fixing screw 2 is much greater than the through hole 11, however, the fixing screw 2 must be introduced into the fixing hole of the depression 12 before the carrier plate 5 and the heat shield plate 10 are clamped together with the aid of the holder 7. Once this has been done the fixing screw 2 is located in a blocking space between the two plates and therefore cannot get lost.

FIG. 2 shows a side view of the inventive heat shield element 1 which is rotated by 90 degrees with respect to the view in FIG. 1.

In this view it can be seen how the retaining element 7 is recessed in the carrier plate 5. The groove 6 in the carrier plate 5 provided for receiving the retaining element 7 is formed in a projection 13 protruding toward the cold side. This projection 13 forms a guide rail 13, preferably one on each side of the carrier plate 5, which is placed in the respective groove 15 of the support structure 16 and allows the carrier plate 5, with the heat shield plate 10 assembled thereon, to be exactly positioned and aligned. The grooves 15 in the support structure 16 do not have to be specially introduced into the support structure for the inventive heat shield element 1 but, as a rule, are already provided for assembly of the normal, one-part ceramic heat shield elements with the aid of the identical retaining elements 7.

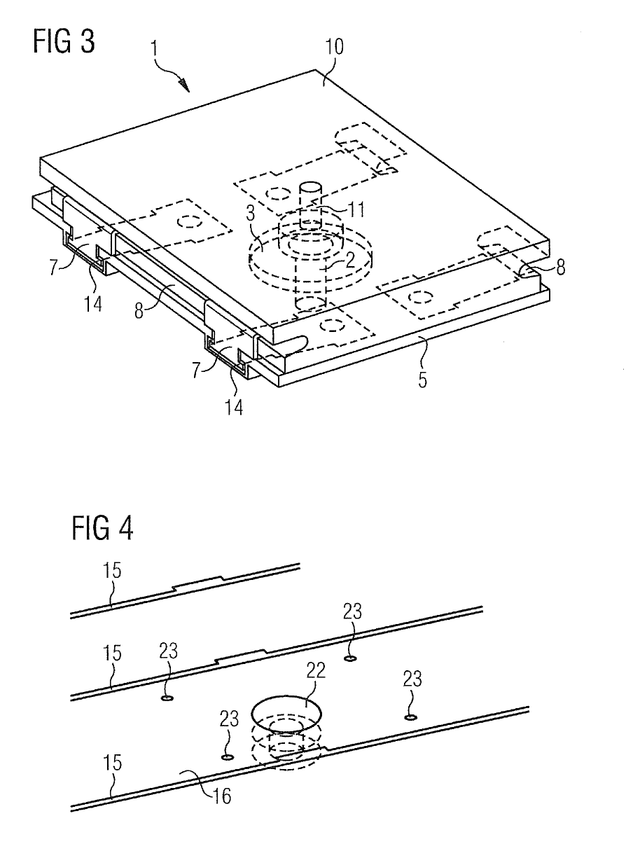

FIG. 3 shows a perspective overall view of the inventive heat shield element 1 which comprises a ceramic heat shield plate 10 and a metal carrier plate 5.

The ceramic heat shield plate 10 and the metal carrier plate 5 are preferably held together by four retaining elements 7. In another embodiment the number of holders 7 can be reduced to at least two, one from each side. For this purpose the holders 7 engage in the holder grooves 8 provided in the two edges of the heat shield plate 10 that oppose and face away from each other. A detailed diagram of this securing is disclosed in more detail in FIGS. 5 and 6. Here the holders 7 are of identical construction, as are conventionally used for securing the one-part ceramic heat shield elements, for example the adjacent ones, but in contrast thereto are assembled on a metal carrier plate 5 positioned between the heat shield plate 10 and the support structure 16.

The through hole 11 is used, as described above, for pushing through a narrow assembly too to screw the fixing screw 2 into the support structure 16 where there is either a thread present or a counter nut is positioned.

FIG. 4 shows a perspective view of the support structure 16, by way of example of a turbine machine.

The support structure 16 comprises parallel grooves 15 in which the one-part ceramic heat shield elements are successively clamped with the aid of the resilient metal holders 7. The last piece of the heat shield is preferably formed with the inventive two-part heat shield element 1.

For this purpose a bore 22 is provided in the support structure 16 at exactly the position of the last heat shield element. The projecting extension 3 of the metal carrier plate 5 of the heat shield element fits into this bore. At the same time the two parallel and correspondingly dimensioned projections 13 are fitted into the parallel, and optionally widened, grooves 15 of the support structure 16, so the inventive two-part heat shield element 1 adopts a precisely predefined position on the support structure 16.

In preferred embodiments the support structure 16 can also comprise cooling openings 23 which are connected to cooling air ducts.

The surface of the support structure 16 can be flat or curved. The curvature can also be convex or concave.

The preferred purpose of the inventive two-part heat shield element 1 is provided as a closing element of the heat shield in an assembly direction determined thereby and which substantially follows the normal on the surface of the support structure. However, in terms of easier access and reduced expenditure for replacing a defective heat shield element, a plurality of closing sites may also be provided in a heat shield row. It is then not necessary to disassemble all heat shield elements of a row in order to replace just a few of them.

The inventive two-part heat shield element 1 also allows simple assembly by one person and from just one side of the plant if a thread device or a thread is provided in the support structure 16 for the fixing screw 2.

FIG. 5 shows a retaining element 7 in a perspective diagram. The retaining element 7 is preferably made from metal and comprises a securing section 18, also called a retaining spring, with which the retaining element 7 can be secured to a support structure 16 of a combustion chamber wall, by way of example the combustion chamber wall of a gas turbine plant.

The retaining elements 7 are guided on the support structure 15 in a groove 6 respectively (cf. FIG. 6).

Here a widened portion of the securing section 18, what is known as the shoe of the retaining element 7, engages with low tolerance in a groove 6 (by way of example approx. 10 mm deep) recessed parallel to the surface of the carrier plate 5. This type of securing of the one-part normal heat shield elements made from ceramic to a support structure 16 is known. According to the invention this known method of securing is accordingly applied to a carrier plate 5 serving as an intermediate element. The advantages of a tested securing method are inventively retained hereby.

The groove 6 is designed in such a way that it has the width required for insertion of the shoe only in the base. When the retaining element 7 is raised in the groove 6 it is supported on the narrow region of the groove 7 imparting a retaining force that holds the retaining element 7. The part of the securing section 18 that is not widened can consequently be raised in the groove 6 unhindered. The securing opening 17 in the shoe serves to fix all or some retaining elements 7 in the groove, and this can take place from the cold side of the carrier plate 5 with the aid of pins, locking grub screws or screw connections. A heat shield element is conventionally held on two opposing sides by two retaining elements 7 respectively, i.e. a total of four retaining elements 7.

In a preferred embodiment the securing sections 3 of the retaining elements 7 arranged on the other side are not secured so they may slide in order not to prevent the thermal expansion of the heat shield element.

A holder head 20 is formed at the end of the retaining spring 18 which opposes the end with the securing opening 17. This holder head 20 has a section 19 bent substantially at a right angle to the retaining spring 18, and a gripping section 21 which is in turn bent substantially perpendicularly to the section 19. The gripping section 21, also called a gripping tab, is used for engagement in the groove of a heat shield element. By way of engagement of gripping tabs 21 of retaining elements 7, which are a secured to a carrier plate 5, a heat shield element can be clamped to the carrier plate in the retaining grooves 8 of sides of the shield plate 10 that face away from each other (see FIG. 6).

FIG. 6 shows an enlarged perspective partial view of the inventive heat shield element 1 in the region of a retaining element 7.

The ceramic heat shield plate 10, shown at the top, with the hot side 9 is arranged here on the metal carrier plate 5 arranged below it and clamped to the retaining element 7 described under FIG. 5. The groove 6 of the carrier plate 5 has a widened groove base and a narrow region 14 through which the retaining spring 18 of the retaining element 7 can exit, while the shoe with the securing opening 17 is restrained.

1.-14. (canceled)

15. A heat shield element for a heat shield which includes a large number of heat shield elements disposed adjacently on a support structure, the heat shield element comprising:
a hot side;
a cold side,
a heat shield plate forming the hot side; and
a carrier plate forming the cold side,
wherein the heat shield plate may be assembled on the carrier plate,
wherein a through hole is provided in the heat shield plate in order to assemble the heat shield plate on the carrier plate,
wherein a position of the through hole is provided substantially as a symmetrical position in a surface of the heat shield plate, and
wherein a transverse dimension of the through hole is provided so as to be smaller than a diameter of a head of a fixing screw which may be inserted in the carrier plate,
wherein a depression having a through hole is provided in the carrier plate at the position corresponding to the through hole of the heat shield plate, through which the fixing screw may be inserted, and
wherein the head of the fixing screw is captured in a space formed by the depression and the side of the heat shield plate facing the carrier plate.

16. The heat shield element as claimed in claim 15, wherein the heat shield plate forming the hot side is constructed from a heat-resistant sintered or ceramic material.

17. The heat shield element as claimed in claim 15, wherein the carrier plate forming the cold side is constructed from a metal material or a metal alloy.

18. The heat shield element as claimed in claim 15, wherein the heat shield plate comprises a respective holder groove, located in two lateral edges that oppose and face away from each other, which is provided for engaging a retaining element by way of a gripping section.

19. The heat shield element as claimed in claim 18, wherein the carrier plate comprises a groove which has a widened groove base and a constricted region forming an open side of the groove.

20. The heat shield element as claimed in claim 19,
wherein the carrier plate and the heat shield plate are clamped together with the aid of at least two retaining elements, and
wherein the retaining element comprises a first means for engaging in the holder groove of the heat shield plate and a second means for engaging in the groove of the carrier plate.

21. The heat shield element as claimed in claim 20, wherein the first means formed in the retaining element for engaging in the holder groove of the heat shield plate is constructed as a plurality of a gripping section.

22. The heat shield element as claimed in claim 15, wherein the second means constructed in the retaining element for engaging in the groove of the carrier plate is constructed as a widened shoe with a first width corresponding to a second width of the widened groove base of the groove of the carrier plate.

23. The heat shield element as claimed in claim 19, wherein the retaining element comprises a securing section serving as a retaining spring with a third width which corresponds with a fourth width of the constricted region of the groove of the carrier plate.

24. The heat shield element as claimed in claim 15, wherein a first thickness of the heat shield plate and a second thickness of the carrier plate produce a total thickness which matches a thickness of a one-part ceramic heat shield element.

25. A heat shield on a support structure including a large number of heat shield elements, comprising:
a heat shield element which is provided as a final heat shield element ending a row of pre-assembled adjacent heat shield elements,
wherein the heat shield element is constructed as claimed in claim 15.

26. The heat shield as claimed in claim 25, wherein the heat shield plate forming the hot side is constructed from a heat-resistant sintered or ceramic material.

27. The heat shield as claimed in claim 25, wherein the carrier plate forming the cold side is constructed from a metal material or a metal alloy.

28. The heat shield as claimed in claim 25, wherein the heat shield plate comprises a respective holder groove, located in two lateral edges that oppose and face away from each other, which is provided for engaging a retaining element by way of a gripping section.

29. The heat shield as claimed in claim 28, wherein the carrier plate comprises a groove which has a widened groove base and a constricted region forming an open side of the groove.

30. The heat shield as claimed in claim 29,
wherein the carrier plate and the heat shield plate are clamped together with the aid of at least two retaining elements, and
wherein the retaining element comprises a first means for engaging in the holder groove of the heat shield plate and a second means for engaging in the groove of the carrier plate.

31. The heat shield as claimed in claim 30, wherein the first means formed in the retaining element for engaging in the holder groove of the heat shield plate is constructed as a plurality of a gripping section.

32. The heat shield as claimed in claim 25, wherein the second means constructed in the retaining element for engaging in the groove of the carrier plate is constructed as a widened shoe with a first width corresponding to a second width of the widened groove base of the groove of the carrier plate.

33. A method for assembling a heat shield element, comprising:
providing a heat shield element as claimed in claim 15;
introducing the fixing screw into a hole provided in the depression; and
clamping the heat shield plate with the aid of at least two retaining elements, which are introduced with their respective shoe into the groove of the carrier plate, to the metal carrier plate by engagement by means of the gripping sections of the retaining elements in the holder grooves provided in the edges of the heat shield plate that face away from each other.

34. The method as claimed in claim 33,
wherein a first retaining element is non-positively secured to the carrier plate at a securing opening, and
wherein a second retaining element opposing the first secured retaining element is left unsecured.
